(19) United States
(12) Patent Application Publication
(10) Pub. No.: US 2015/0087077 A1
(43) Pub. Date: Mar. 26, 2015

(54) SAMPLE COLLECTION DEVICE FOR OPTICAL ANALYSIS

(71) Applicant: Quick LLC, Farmington, NY (US)

(72) Inventors: David Anthony Mucci, Farmington, CT (US); Ronald Gary Clark, JR., Southbury, CT (US); James Scott Fox, Farmington, CT (US)

(21) Appl. No.: 14/496,097

(22) Filed: Sep. 25, 2014

Related U.S. Application Data
(60) Provisional application No. 61/882,718, filed on Sep. 26, 2013.

(51) Int. Cl. G01N 1/10; B32B 37/18

(52) U.S. Cl. CPC G01N 1/10; B32B 37/18
USPC 436/174; 422/527; 156/60

(57) ABSTRACT

A sample collection device is provided, which includes a laminate structure which includes at least a first layer and a second layer and a channel sandwiched between the two layers. The channel has an opening at a first end of the laminate structure. The first layer includes a depressible bulb pump disposed distal to the opening of the channel. Depressing and releasing the bulb pump draws a fluid or liquid sample into the channel. The sample collection device can further includes a pad attached to the laminate structure for providing structural support and easy handling. The layers of the sample collection device can be IR neutral so that the device can be used in association with a portable IR or near-IR spectroscopy unit for analyzing the collected sample.

### CROSS REFERENCES TO RELATED APPLICATION

This application claims priority to U.S. Provisional Application No. 61/882,718, filed Sep. 26, 2013, the disclosure of which is incorporated by reference herein in its entirety.

### FIELD OF THE INVENTION

The invention generally relates to a sample collection device for uptaking fluids or liquids, such as biological solutions or fluids. The sample collection device can be used in association with a portable optical analyzer.

### BACKGROUND

Microfluidics deals with the behavior, precise control and manipulation of fluids that are geometrically constrained to a small, typically sub-millimeter, and scale. The behavior of fluids at the micro scale can differ from “microfluidic” behavior in that factors such as surface tension, energy dissipation, and fluidic resistance start to dominate the system. In particular, the Reynolds number (which compares the effect of momentum of a fluid to the effect of viscosity) can become very low. A key consequence of this is that fluids, when side-by-side, do not necessarily mix in the traditional sense; molecular transport between them must often be through diffusion.

Currently available microfluidic structures include micro pneumatic systems, i.e. microsystems for the handling of off-chip fluids (liquid pumps, gas valves, etc.), as well as structures for the on-chip handling of nano- and pico-liter volumes. Significant research has been applied to the application of microfluidics for the production of industrially relevant quantities of material. Inkjet print head is an example of successful commercial application of microfluidics.

Advances in microfluidics technology are revolutionizing molecular biology procedures for enzymatic analysis (e.g., glucose and lactate assays), DNA analysis (e.g., polymerase chain reaction and high-throughput sequencing), and proteomics. The basic idea of microfluidic biochips is to integrate assay operations such as detection, as well as sample pre-treatment and sample preparation on one chip.

An emerging application area for biochips is clinical pathology, especially the immediate point-of-care diagnosis of diseases. In addition, microfluidics-based devices, capable of continuous sampling and real-time testing of air/water samples for biochemical toxins and other dangerous pathogens, can serve as an always-on “bio-smoke alarm” for early warning.

With the advances in portable technologies incorporating optical sensors and detector, samples can be analyzed in portable devices, such as in near infrared (near IR) and infrared (IR) ranges. U.S. application Ser. No. 13/929,882, published as 2014/0027641, describes such a portable system, the disclosure of which is incorporated by reference in its entirety.

There is a need for a light, low-cost, and easy-to-use sample holder or cartridge for collecting and holding a fluid or liquid sample to be analyzed for portable spectroscopic analyzer systems.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, one aspect of the disclosed subject matter is directed to a sample collection device that includes a laminate structure. The laminate structure has a first end and a second end, and includes a first layer, a second layer, and a channel sandwiched between the first layer and the second layer and extending in a direction from the first end to the second end. The channel has an opening at the first end of the laminate structure. The first layer includes a depressible bulb pump disposed distal to the opening of the channel. The bulb pump is formed by a raised portion of the first layer and encloses a chamber therein, which is in fluidic communication with the channel.

In some embodiments of the sample collection device, the first layer and the second layer collectively do not substantially absorb light in the spectral ranges of between 650 nm and 15,000 nm.

In some embodiments, each of the first layer and the second layer comprises a polymer film. For example, the polymer film can be made of fluorinated ethylene propylene (FEP). The polymer film can be surface treated to be hydrophilic.

In some embodiments, the laminate structure further includes a spacer sandwiched between the first layer and the second layer, where the spacer includes an internal opening forming side walls of the channel. The spacer can include a pressure sensitive adhesive.

In some embodiments, the disclosed sample collection device further comprises a pad at least partially attached to the second layer of the laminate structure. In some embodiments, the pad includes a cut window exposing at least a portion of the second layer corresponding to the channel. In some embodiments, the pad can be attached by the laminate structure by mounting gasket which also includes a cut window aligned with the cut window on the pad. The mounting gasket can include a pressure sensitive adhesive. In certain embodiments, the pad can comprise a grasping area extending beyond the first end of the laminate structure. In certain embodiments, the pad can include a weakened area that facilitates the bending of a portion of the pad that includes the grasping area away from the laminate structure.

In another aspect, the disclosed subject matter provides a method of making a sample collection device. The method includes: providing a generally planar first layer which includes an elevated area formed by a portion of the first layer, a generally planar second layer, and a spacer layer which includes an internal opening having a proximal opening end and a bottom; laminating the first layer, the second layer, and the spacer layer to form a laminating structure such that the spacer layer is sandwiched between the first layer and the second layer, the elevated area of the first layer is disposed distal to the proximal opening end of the spacer and protruding away from the second layer, and the internal opening of the spacer layer together with the first layer and the second layer form a channel which is in fluidic communication with the space encompassed by the elevated area of the first layer; and attaching a pad to second layer of the laminate structure by a mounting gasket. In the method, each of the first layer and the second layer can be a polymer film, and each of the spacer layer and the mounting gasket can include a pressure sensitive adhesive. The pad and the mounting gasket each can include a cut window which are aligned to expose at least a portion of the second layer corresponding to the channel.

In a further aspect, the disclosed subject matter discloses a method of collecting a fluid sample using the sample collection device described herein. The method includes contacting the channel opening with a fluid sample, and depressing and releasing the bulb pump on the first layer of the laminate structure of the sample collection device to draw at least a portion of the sample to enter at least a portion of the channel. When the sample collection device includes a pad partially attached to the laminate structure and has a grasping area extending out from the channel opening, before contacting the channel opening with the fluid sample, a user can use the grasping area of the pad to bend an unattached portion of the pad away from the laminate structure so as to more fully expose the channel opening for contacting the fluid sample.

### BRIEF DESCRIPTION OF THE DRAWINGS

The disclosed subject matter will be more fully understood by reference to the following figures.

FIG. 1 is a top view of a sample collection device according to one embodiment of the disclosed subject matter.

FIG. 2 is an exploded view of the sample collection device depicted in FIG. 1.

FIG. 3 is a side view of the sample collection device depicted in FIG. 1.

FIG. 4A is a cross section view along line A-A of the sample collection device depicted in FIG. 1.

FIG. 4B is a cross section view along line B-B of the sample collection device depicted in FIG. 1.

While the disclosed subject matter is capable of various modifications and alternative forms, specific embodiments thereof have been depicted in the figures, and will herein be described in detail. It should be understood, however, that the figures are not intended to limit the subject matter to the particular forms disclosed but, to the contrary, the intention is to illustrate and include all modifications, equivalents, and alternatives within the spirit and scope of the subject matter as defined by the appended claims.

### DETAILED DESCRIPTION

While the disclosed subject matter may be embodied in many different forms, reference will now be made in detail to specific embodiments of the disclosed subject, examples of which are illustrated in the accompanying drawings. This description is an exemplification of the principles of the disclosed subject and is not intended to limit the invention to the particular embodiments illustrated.

In one aspect, the disclosed subject matter provides a sample collection device for drawing and holding a fluid or liquid sample. The device can be used in association with a portable spectroscopy unit for optical analysis, e.g., absorption spectroscopy in certain spectral ranges, such as IR or near-IR spectral ranges. The disclosed subject matter also provides methods of making the sample collection device, as well as methods for using the sample collection device.

For purpose of illustration and not limitation, various embodiments of the sample collection device and related methods of making and using the device of the disclosed subject matter are described below in connection with drawings. It is noted that the figures are not necessarily drawn to scale and certain dimensions have been exaggerated for clarity. It is also noted that although particular shapes (e.g., rectangles) are drawn to illustrate certain features of the device, the invention is not limited to these particular shapes.

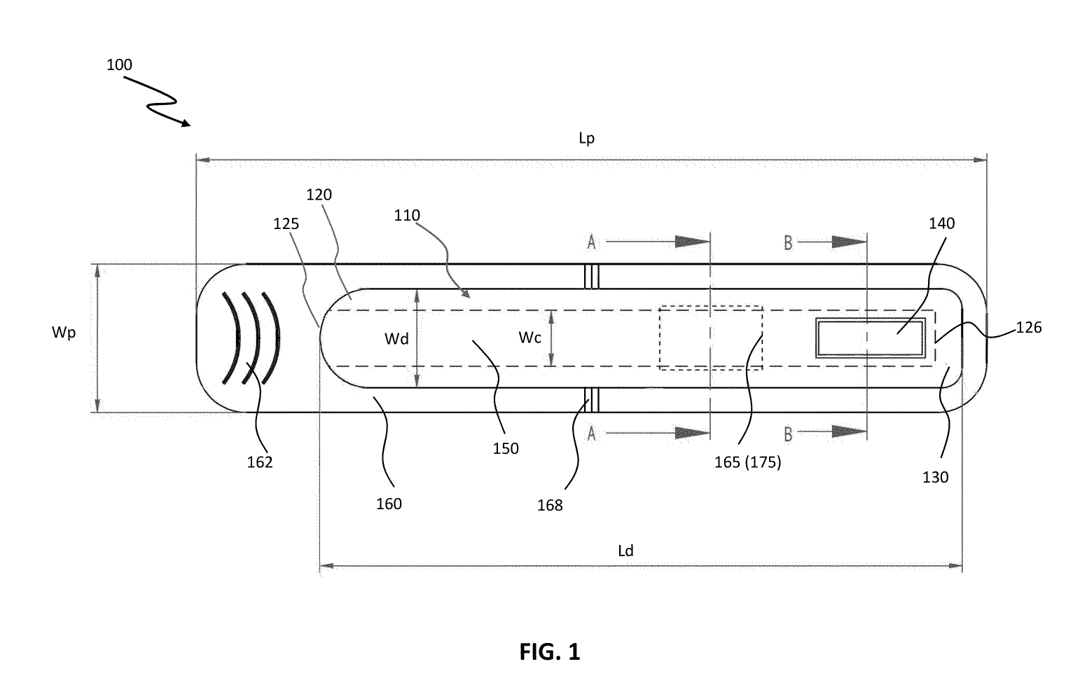

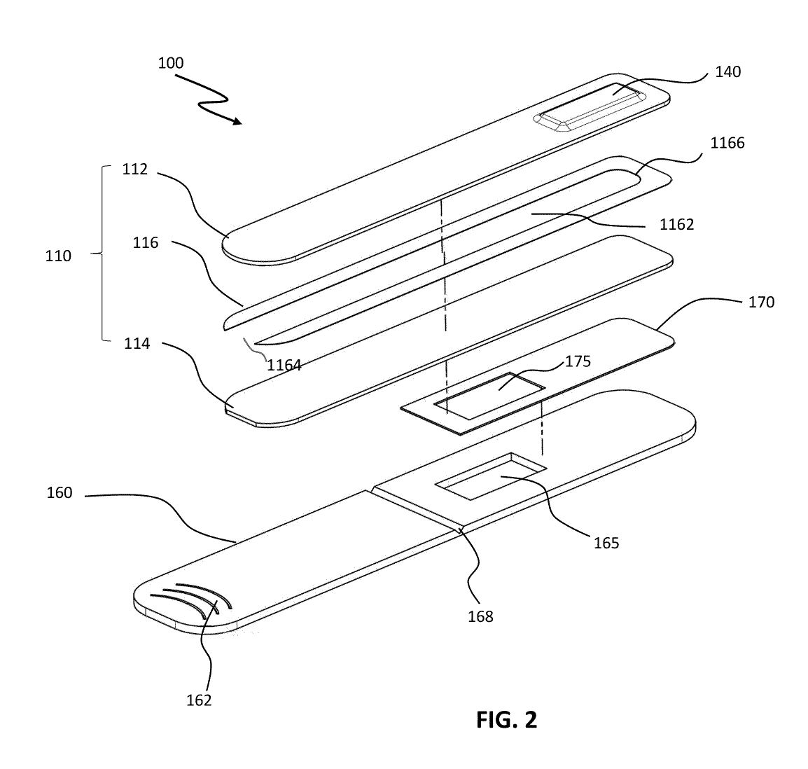

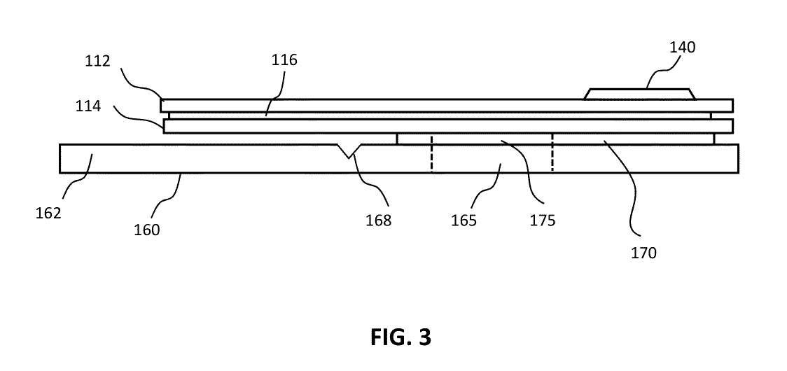

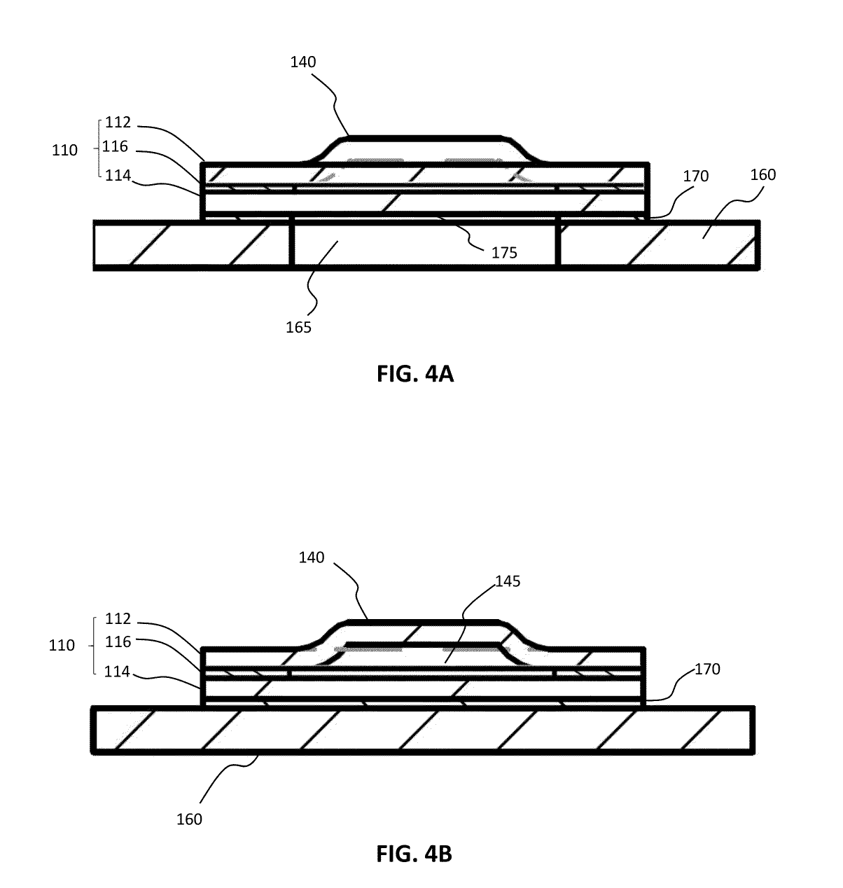

FIG. 1 is a top view of a sample collection device according to one embodiment of the present invention. FIG. 2 depicts an exploded view of the sample collection device of FIG. 1; FIG. 3 is a side view of the sample collection device; FIGS. 4 and 5 are cross section views of the sample collection device along the lines of A-A and B-B in FIG. 1. Same reference numerals are used throughout these figures to denote the same features. The structure of the sample collection device is described herein below by referring to all the figures.

The sample collection device 100 (which is also referred to herein as the sample holder or solution holder) comprises a laminated structure 110 which comprises at least two layers (e.g., an upper layer 112 and a lower layer 114 as shown in FIG. 2). The laminate structure is generally planar, and has a proximal end 120 and a distal end 130 (FIG. 1), and includes a channel 150 sandwiched between the two layers and extending from the proximal end 120 to the distal end 130 (and running substantially the whole length of the laminated structure 110). The channel has an opening 125 at the proximal end 120 of the laminate structure 110, and is closed at the other end 126. Furthermore, the laminate structure 110 comprises a bulb pump 140 disposed distal to the channel opening 125, e.g., near the distal end 130 of the laminate structure 110. The bulb pump 140 can take the form of an elevated area in the upper layer 112, as depicted in FIG. 2, which encloses a space or chamber 145 therein (not shown in FIG. 1 or 2 but more clearly shown in FIG. 4B) which is in fluidic communication with the channel 150. As shown in FIG. 4B, the bulb pump 140 can be formed as an integral part of the upper layer 112, e.g., by molding or other processing techniques that stretch or deform an otherwise planar portion of the upper layer 112.

The bulb pump is designed to assist the drawing of a fluid or liquid sample from the opening 125 of the channel into the interior of the channel. When the bulb pump is depressed, e.g., by a user's finger(s), at least a portion of the air contained in the chamber and the channel is pushed out. When the user releases the pressure from the bulb pump, the bulb pump rebounds toward its original shape due to elasticity of the material, thereby creating a partial vacuum in the channel and the chamber. The vacuum thus created by the depression-release action (pumping action) helps to draw the fluid or liquid sample in touch with the opening of the channel into the channel. If needed, multiple pumping can be performed to draw the desired amount of fluid or liquid sample into the channel for analysis.

As illustrated in FIG. 2, the channel 150 can be formed by a spacer 116 sandwiched between the upper layer 112 and lower layer 114. In such a case, the spacer 116 is also part of the laminate structure. The spacer 116 takes a general U-shape and has an internal opening 1162 which has a proximal open end 1164 and a bottom 1166. The internal opening 1162 together with the upper layer 112 and lower layer 114 form the channel 150, with the internal opening 1162 forming the two side walls for the channel 150, and the upper layer 112 and lower layer 114 forming the ceiling and floor of the channel 150. Alternatively, the channel can also be formed without the spacer layer, e.g., formed within one of the laminate layers. For example, the upper layer can be molded to form an elevated region running from the proximal end 120 to the distal end 130, and then directly laminated with the lower layer 130 and form a channel without using a spacer.

Both the upper layer 112 and the lower layer 114 can be made of a polymer film. The polymer film for the upper layer and lower layer can be the same or different. For applications in IR or near-IR analysis of the fluid or liquid sample to be collected by the sample collection device, the material, thickness and construction for the upper layer 112 and the lower layer 114 should be such that the upper layer 112 and the lower layer 114 collectively do not substantially absorb light falling in wavelength ranges of interest, e.g., 650 nm-15,000 nm in the IR and near-IR range (i.e., they do not absorb more than 10% of the light in the spectral range of interest, which is also referred to as IR neutrality). IR neutrality below 3500 nanometers may be the most useful range for the disclosed subject matter, as water is known to highly absorb infrared light above this range.

Capillary action may also be exploited in the wicking of the sample fluid into the channel 150. When a naturally hydrophobic polymer film is used for the upper layer 112 and lower layer 114, these layers (or at least the surfaces of the layers that form the ceiling and the floor of the channel 150) can be made hydrophilic by commonly known surface treatment techniques in the field, e.g., plasma irradiation, ultraviolet irradiation, chemical etching, or coating with hydrophilic agents, such as surfactants.

The spacer 116 can be a pressure sensitive adhesive (PSA) tape, e.g., a double-sided PSA tape having a polymer film backing, or a PSA layer with no polymer film backing. The spacer 116 can also be a polymer film having adhesives coated on its upper and lower surfaces. Alternatively, the spacer 116 can a polymer film that is thermally sensitive so as to permit heat-welding of the upper layer 112 and the lower layer 114.

As shown in FIGS. 1 and 2, the sample collection device further includes a pad 160, a portion of which is attached to the lower layer 114 via a mounting gasket 170. The pad 160 need not be transparent or IR neutral, and can be made of any suitable materials, such as paper, plastics (such as polypropylene), inorganic materials (such as glass, metal, ceramics), etc. Preferably, the pad is made of a material and constructed such that it provides structural rigidity for the user to handle for the device. For optical analysis of the sample drawn into the channel 150, the pad includes a cut window 165, which is aligned with the cut window 175 on the mounting gasket 170, and exposes at least a portion of the lower layer 114 (which constitutes the floor of the channel 150) to permit light to shine through a portion of the channel 150. When the device is used in a spectrometer, the cut windows 165 and 175 are aligned with the optical path of the spectrometer. Like the spacer 116, the mounting gasket 170 can be of a PSA material or other materials having needed adhesive properties to attach the pad 160 to the lower layer 114.

The pad 160 can include an area 162 extending out from the proximal end 120 of the laminate structure. The area 162 can be used by a user as a grasping area for handling the sample collection device. The pad 160 can also include a weakened area, e.g., a cutout groove 168. The portion of the pad 160 from groove 168 toward the proximal end (i.e., the grasping area 162) is not attached to the lower layer 114. Thus, the groove 168 can serve as a hinge to facilitate the flexing of this unattached portion of the pad away from the laminate structure, thereby making the opening of the channel more accessible to the sample fluid or solution to be collected. For example, a user can use the grasping area 162 of the pad 160 to bend away the portion of the pad proximal to the cutout groove 168, so that she can put the proximal tip of the laminate structure (where the channel opening is located) in her mouth to more easily provide her saliva to be wicked into the channel for optical analysis. When the sample collection is complete, the pad 160 can be bent back into its original, straight position for storage, transport, or insertion into a spectroscopic analyzer unit. As an illustrative example, the materials and dimensions of the various components of the sample collection device 100 can be as follows:

upper layer 112: made of fluorinated ethylene propylene (FEP); thickness (height)=0.25 mm; length Ld=60 mm; width Wd=10 mm;

lower layer 114: made of FEP; thickness (height)=0.25 mm; length slightly smaller than 60 mm (e.g., 58-59 mm); and width=10 mm. (The reason for the length of the lower layer being slightly smaller than the length of the upper layer is to give a slight canting inward of the channel intake opening thus helping to prevent blocking of the opening by stopping the intake from sitting flush against the back wall of the container for the sample to be drawn, which can be a mouth of a human, or an artificial container);

spacer 116: made of silicone PSA; thickness =0.125 mm; width =10 mm; width of the internal opening 1162 We=5 mm;

pad 160: made of polypropylene; thickness=0.8 mm; length Lp=80 mm; width Wp=15 mm;

mounting gasket 170: made of silicone PSA; thickness=0.125 mm;

cut window 165 on the pad 160: width=6 mm and length=12 mm.

bulb pump: the size of the bulb pump depends on the type of fluid of the sample to be collected, the fluid viscosity and the volume needed to be drawn into the channel.

It is noted that the above dimensions are only illustrative and can be increased or reduced as needed or desired, e.g., the rigidity of the polymer film(s) used for the laminated structure; the sample fluid or liquid to be collected, the slot size of the portable analyzer unit which accommodates the sample collection device, etc.

The laminate structure 110 can be manufactured by any known techniques for producing multi-layered laminate structure. For example, a reel-to-reel process can be employed to adhere or otherwise bond the layers to form the integral laminate structure. The bulb pump 140 on the upper layer 112 can be pre-formed by a molding process, e.g., by using vacuum suction when the polymer film is wound on a heated drum or roller. The pad 160 can be attached separately after the laminate structure 110 is formed, and by a similar reel-to-reel process.

The sample collection device described herein can be used on a hand-held, portable, mobile spectroscopy system, which can be wirelessly coupled with a smart phone, tablet, computer, and other data acquisition devices via near field communication, Wi-Fi, Bluetooth, radio, satellite, or other wireless means.

The sample collection device can be used as a single use (i.e., disposable) or multiple use unit. Sample fluid or liquid that may be collected for testing include, but are not limited to, saliva, urine, water, blood, amniotic fluid, tears, sweat, nasal secretions, other human or animal body fluids, biological waste, biological by-products, environmental waste, or other material analysis to name a few.

The device can be used for analysis for disease diagnosis and management, determining levels of specific substances in solution, the quantifying and/or qualifying of individual or multiple substances in solutions, analyzing naturally occurring solutions, analyzing synthetic solutions, symptom analysis, post procedure monitoring, and other applications pertaining to humans, animals, plants, the environment, and both living and non-living entities that require the monitoring and measuring of substances in liquid or solid forms.

Applications of the disclosed subject matter include, but are not limited to the following:

1. Disease diagnosis from blood samples including, but not limited to, parasitic or bacterial infections (e.g. malaria, Chagas, Leishmaniasis, sleeping sickness, sepsis, gonorrhea, N. meningitidis infection), disorders of the red blood cells, (sickle cell anemia, thalassemia, anemia, lead poisoning, spherocytosis, pyruvate kinase disease, disorders of the white blood cells (leukemia, Chedik-Higashi syndrome, vitamin deficiencies), and platelet disorders (low or high count, immune mediated thrombocytopenic purpura), or other blood disorders, medical disease or condition.

2. Diagnosis of diseases or pathology from blood, saliva, or tears, including but not limited to alcohol abuse, diabetes, ongoing glucose monitoring, diabetes of pregnancy, drugs of abuse, natural and synthetic hormonal levels and/or presence or body levels of natural or synthetic medications, or other medical disease or condition that requires monitoring.

3. Diagnosis of diseases or pathology from urinary samples, including but not limited to, pregnancy, urinary tract infection, drugs of abuse, metabolic status of the patient (such as metabolic acidosis, dehydration, diabetic ketoacidosis), kidney stones, hematuria, or other conditions that can be diagnosed or monitored in urine.

4. Diagnosis of diseases or pathology from spinal fluids, including but not limited to, meningitis, encephalitis, Lyme disease, or other medical disease or condition. This system is also capable of, but not limited to, analyzing vitreous fluid for post mortem analysis of electrolytes, toxins, or other substances, for use in, but not limited to, forensics, medical autopsy, or other uses.

5. Diagnosis of diseases or pathology from synovial fluid, including but not limited to, Gout, Synovitis, septic fluid or other medical disease or condition.

6. Diagnosis of diseases or pathology from the sputum, including but not limited to, Tuberculosis, pneumonia, cystic fibrosis, or other medical disease or condition. This system is also capable of, but not limited to, analyzing fecal material for disease diagnosis/pathology, presence of stool infections, or other disease conditions manifested in stool.

7. Diagnosis of diseases or pathology from pus or wound discharge, but not limited to, Yaws, Lyme disease, N. Gonorrhea, MRSA, VRE or other medical disease or condition. This system is also capable of, but not limited to, analyzing penile or vaginal secretion for disease diagnosis/pathology, presence of sexually transmitted diseases, or other genital conditions.

Additional applications of the disclosed subject matter include, but are not limited to:

1. The wicking and holding liquid for spectroscopy analysis of soil or water samples in the field, including but not limited to standing water, pond, river, lake, ocean, for composition analysis and monitoring of properties both public and private.

2. Remote and/or continuous monitoring of soil, water, or other environmental samples for health and safety.

3. Immediate liquid sampling for spectroscopy of microorganisms and/or contamination that cannot be tested in a lab setting.

4. Monitoring of material, soil, water, or other environmental samples for health, safety, or other use. This monitoring can be done in the field or environment or from a remote location.

Although the description above contains many details, these should not be construed as limiting the scope of the invention but as merely providing illustrations of some of the embodiments of the invention. Therefore, it will be appreciated that the scope of the present invention fully encompasses the variations of the disclosed embodiments, which may become obvious to those skilled in the field of this invention.

What is claimed is:

1. A sample collection device, comprising:
a laminate structure having a first end and a second end, the laminate structure including:
a first layer
a second layer,
a channel sandwiched between the first layer and the second layer and extending in a direction from the first end to the second end, the channel having an opening at the first end of the laminate structure,
wherein the first layer includes a depressible bulb pump disposed distal to the opening of the channel, the bulb pump formed by a raised portion of the first layer and enclosing a chamber therein, the chamber being in fluidic communication with the channel.

2. The sample collection device of claim 1, wherein first layer and the second layer collectively do not substantially absorb light in the spectral ranges of between 650 nm and 15,000 nm.

3. The sample collection device of claim 1, wherein each of the first layer and the second layer comprises a polymer film.

4. The sample collection device of claim 1, wherein the polymer film is made of fluorinated ethylene propylene (FEP).

5. The sample collection device of claim 1, wherein at least one of the first layer or the second layer is treated to be hydrophilic.

6. The sample collection device of claim 1, wherein the laminate structure further includes a spacer sandwiched between the first layer and the second layer, the spacer including an internal opening forming side walls of the channel.

7. The sample collection device of claim 6, wherein the spacer comprises a pressure sensitive adhesive.

8. The sample collection device of claim 1, further comprising a pad at least partially attached to the second layer of the laminate structure, the pad including a cut window exposing at least a portion of the second layer corresponding to the channel.

9. The sample collection device of claim 8, further comprising a mounting gasket sandwiched between the second layer of the laminate structure and the pad, the mounting gasket including a cut window aligned with the cut window on the pad.

10. The sample collection device of claim 9, wherein the mounting gasket comprises a pressure sensitive adhesive.

11. The sample collection device of claim 8, wherein the pad comprises a grasping area extending beyond the first end of the laminate structure.

12. The sample collection of device of claim 11, wherein the pad further comprises a weakened area facilitating the bending of a portion of the pad that includes the grasping area away from the laminate structure.

13. A method of making a sample collection device, comprising:
providing:
a generally planar first layer, the first layer including an elevated area formed by a portion of the first layer,
a generally planar second layer,
a spacer layer which comprises an internal opening having a proximal opening end and a bottom;
laminating the first layer, the second layer, and the spacer layer to form a laminating structure wherein the spacer layer is sandwiched between the first layer and the second layer, and wherein the elevated area of the first layer is disposed distal to the proximal opening end of the spacer and protruding away from the second layer, and wherein the internal opening of the spacer layer together with the first layer and the second layer form a channel which is in fluidic communication with the space encompassed by the elevated area of the first layer; and
attaching a pad to second layer of the laminate structure by a mounting gasket.

14. The method of claim 13, wherein each of the first layer and the second layer comprises a polymer film, and wherein each of the spacer layer and the mounting gasket includes a pressure sensitive adhesive.

15. The method of claim 13, wherein the pad and the mounting gasket each include a cut window which are aligned to expose at least a portion of the second layer corresponding to the channel.

16. A method of collecting a fluid sample, comprising:
providing a sample collection device, the device comprising:
a laminate structure having a first end and a second end, the laminate structure including:
a first layer
a second layer,
a channel sandwiched between the first layer and the second layer and extending in a direction from the first end to the second end, the channel having an opening at the first end of the laminate structure,
wherein the first layer includes a depressible bulb pump disposed distal to the opening of the channel, the bulb pump formed by a raised portion of the first layer and enclosing a chamber therein, the chamber being in fluidic communication with the channel; and
a pad which is at least partially attached to the second layer of the laminate structure, the pad including a cut window exposing at least a portion of the second layer corresponding to the channel;
contacting the opening of the channel of the sample collection device with a fluid sample;
depressing and releasing the depressible bulb pump to draw an amount of fluid sample into at least a portion of the channel.

17. The method of claim 16, wherein the pad further includes a grasping area extending beyond the first end of the laminate structure, the method further comprising:
before contacting the opening of the channel of the sample collection device with the fluid sample, using the grasping area to bend an unattached portion of the pad away from the laminate structure.
